(19) United States
(12) Patent Application Publication
(10) Pub. No.: US 2025/0321145 A1
(43) Pub. Date: Oct. 16, 2025

(54) PLURAL ULTRASONIC WAVEGUIDE MEASUREMENTS OF SPATIALLY DISTRIBUTED PROPERTIES

(71) Applicant: Government of the United States as represented by the Secretary of the Air Force, Wright-Patterson AFB, OH (US)

(72) Inventors: Ming Chen, Beavercreek, OH (US); Mikhail Skliar, Salt Lake City, UT (US)

(21) Appl. No.: 19/177,954

(22) Filed: Apr. 14, 2025

Related U.S. Application Data
(60) Provisional application No. 63/634,136, filed on Apr. 15, 2024.

(51) Int. Cl. G01K 11/24; G01K 3/14

(52) U.S. Cl. CPC G01K 11/24; G01K 3/14

(57) ABSTRACT

A system and method for monitoring intensive properties in an extreme environment, such as a boiler or other hostile temperature. The intensive properties include temperature, temperature, elasticity, density, strength, and any other properties which effect changes in the ultrasound propagation velocity. The system plural fibers ultrasonically communicating joined at distal ends to a transducer which emits ultrasonic pulses through and to the distal ends of the fibers. The fibers have mutually different length, resulting in mutually different propagation times for echoes from the distal ends back to the transducer. Changes in the intensive property under consideration result in corresponding changes in the propagation times of ultrasonic pulses from the proximal end of the fiber to the distal end and back.

### CROSS REFERENCE TO RELATED APPLICATION

This application claims priority to and the benefit of U.S. provisional application 63/634,136, filed Apr. 15, 2024, the contents of which are incorporated herein by reference.

### RIGHTS OF THE GOVERNMENT

The invention described herein may be manufactured, licensed and used by and for the Government of the United States for all governmental purposes without the payment of any royalty.

### FIELD OF THE INVENTION

The present invention relates to ultrasonic waveguides configured to determine intensive properties and more particularly to such waveguides which provide differential echogenic responses usable to determine temperature distributions.

### BACKGROUND OF THE INVENTION

Extreme environments include harsh conditions of temperature, pressure, oxidation, shock and/or electromagnetic effects. Such harsh conditions exist, for example, within the combustion chambers of rocket engines, during energy conversion, during material processing and in aerospace applications. Extreme environments have been characterized by using inserted sensors which are treated to withstand harsh conditions, but are typically limited to model based, inferential measurements or limited to noninvasive measurements.

For example, tolerant insertion sensors in the prior art were designed to withstand exposure to extreme environments. Such sensors utilize protective sheathing, active mitigation measures (e.g., cooling) or resiliently appropriate materials. But protective sheaths are subject to breach and active cooling adds complexity. One particular attempt in the art uses pointwise and distributed temperature measurements with glass fiberoptic transducers—such as fiberoptic Bragg grating (FBG), optical resonator cavity, and fluorescence. But these transducers degrade as the temperature approaches 1,000° C., at which temperature silica fiber loses mechanical strength and becomes brittle. By replacing the glass with sapphire, the range of measurable temperatures has been extended somewhat, but commercial manufacturing of single-crystal sapphire fibers with high-temperature cladding has remained elusive.

Yet, some environments are so harsh that even the most robust insertion sensors do not survive prolonged exposure. When insertion sensor measurements are infeasible, the interdependence between process variables becomes necessary in order even estimate properties based on the available data. Estimation of inaccessible states or properties using the available secondary measurements is variably known in the art as soft sensing, virtual metrology, inferential measurements, causal interference or state estimation. A model is needed to perform the inference, whether empirical or based on first principles, and must be validated by the direct measurements of the properties to be estimated and still be adaptable to changing process conditions and disturbances which may require further validation at the expense of time and cost. But the inherent dependence of soft sensing on a model is inherently less reliable than direct measurements.

Other attempts in the art include noninvasive measurement modalities that rely upon electromagnetic fields. Such fields have spectral ranges including RF, optical, X-ray gamma-ray and acoustic/ultrasonic responses in fluids or solids. Yet other signals such as electrical capacitance, electrical resistance and magnetic resonance have been used to gauge the states and properties of interest. In a forgiving environment, a noninvasive quantification, such as nondestructive evaluation (NDE) could be an alternative to traditional insertion sensors. But (NDE) techniques are typically used on-demand, as-needed or at pre-determined infrequent inspections. NDE is unsuitable for or requires modifications in order to provide for repeated online measurements with an adequate sampling rate to monitor processes and to provide feedback on environmental conditions to control process and systems operations.

Optical techniques are among the noninvasive sensing modalities capable of temperature measurements of extreme environments. But optical techniques are limited to line of sight, which may be impossible to establish. And even if possible, laborious effort is often required to maintain an optically transparent line-of-sight in many applications.

Acoustic pyrometry is a noninvasive thermometry method built on the dependence of the speed of sound (SOS) on the gas temperature. Acoustic pyrometry has been applied to energy conversion and other industrial applications. The attenuation of acoustic signals in gasses limits the frequency of acoustic excitations that can be used for pyrometry, which may cause interference from acoustic emissions by turbulent flows, combustion instabilities, and other pressure oscillations in the acoustic range. Furthermore, when the temperature is nonuniform, data from multiple transducer/receiver pairs are needed to tomographically estimate any spatial distribution. Low frequency wavelengths of acoustic signals limit the achievable spatial resolution of temperature measurements. Furthermore, in reacting gas environments, the uncertainty and temporal and spatial variability in gas composition have led to errors of temperature measurements.

In noninvasive ultrasonic thermometry of fluids, the primary data represent changes in the propagation velocity of the pressure wave calculated from the arrival delays of transmitted or echo signals between the transducer and the receiver. Mechanical vibrations in solids are elastic and more complex. Such vibrations may take a form of different modes, including primary (longitudinal) vibrations, secondary (shear) vibrations, and surface elastic waves that propagate with different velocities, all of which are temperature-dependent and may be used in thermometry.

Speed of sound [SOS] is used herein to designate the velocity of the ultrasound propagation in solids, recognizing this terminology deviates from strict definition of the speed of sound as the velocity of pressure waves in gases and liquids. According to the present invention, internal and surface temperatures of solid media are obtained by ultrasonic thermometry. As used herein ultrasonic frequencies range from 20 kHz Hz to 100 MHz and preferably from 100 kHz to 50 MHz. Frequencies greater than 50 MHz are useful for characterizing thin film structures. Lower frequencies decrease ultrasonic attenuation by reducing the achievable spatial resolution.

When the ultrasound wave propagates through an isothermal medium, for which the SOS as a function of the temperature is known, the characterization of unknown temperature, T, can be calculated according to the prior art. Apparent speed of the ultrasound propagation, c, is first calculated from the measurements of the time of flight (TOF, t_{of}) an ultrasound signal takes to reach a receiver located at a distance L from a transducer. By inverting the calibration relationship between the SOS and the temperature, c=f(T), an unknown isothermal temperature is found by its inversion: T=f⁻¹(c). In a pulse-echo mode, a transducer and a receiver is the same device. An unknown isothermal temperature is then found as

$$T = {f}^{- 1} ( \frac{2 L}{{t}_{of}} ) .$$

But isothermal conditions are rare in most environments, systems, and processes. Instead, large thermal gradients are prominent in hypervelocity environments, energy conversion environments and chemical conversion environments. Prior art techniques are insufficient for these environments.

Accordingly, the prior art systems which operate in and control sensing systems in extreme environments suffer from errors, complexity, signature and large form factors that limit utility while introducing undue risk. For example, insertion sensors require penetration of protective barriers used to contain or limit the effects of extreme environments. Penetration creates engineering and material selection challenges (e.g., to match the thermal expansion of sensor and containment materials) and containment breach risks. Clearly a new approach is needed which overcomes these disadvantages. Accordingly, a new approach is needed which provides for noninvasive measurement of intensive properties and which can provide high density measurements of discrete locations in extreme environments.

### SUMMARY OF THE INVENTION

In an extreme environment, when the temperature changes with position z and time t, the TOF of an ultrasound signal convolutes unknown temperature distribution T(t,z) along the entire ultrasonic propagation path from a transducer to a receiver. In pulse-echo mode, the transduction of the ultrasonic excitation pulse and receiving the ultrasonic response to it is performed by the same device, referred to as transducer, which performs both functions. The relationship between t_{of}(t) measured at time t and T(t,z) is given by the nonlinear integral:

$${t}_{of} ( t ) = 2 {\int }_{0}^{L ( T ( t , z ) )} \frac{1}{c ( T ( t , z ) )} dz , \qquad ( 1 )$$

wherein the transducer is located at z=0.

The mapping of the temperature distribution into the ultrasound TOF t_{of}(t) defined by this equation, is not unique, meaning that a plurality of distributions T(t,z) will result in the same value of t_{of}(t). But only one distribution is correct. Additional information is required to determine the correct T(t, z) corresponding to the measured t_{of}(t). Such information requires supplementary measurements, constraints on the allowable temperature distribution or both.

For example, the combination of ultrasonic TOF measurements obtained with a single stationary transducer operating in the pulse-echo mode, IR imaging of surface temperature and the requirement for T(t, z) to satisfy a particular partial differential equation describing the heat conduction are sufficient to noninvasively obtain the three-dimensional distribution of internal and surface temperatures and heat fluxes inside a non-uniformly heated cementitious sample.

The method and apparatus according to the present invention use distinct ultrasonic thermometry. Particularly, as described and claimed herein, measurements of segmental temperature distribution (MSTD), use at least one echogenically segmented propagation path to provide multiple echoes responsive to one or more ultrasonic excitations. The MSTD advantageously resolves the lack of unique dependence between the measured t_{of}(t) and the unknown T(t,z) by: 1. using an ultrasound propagation path with multiple echogenic features, which create a train of ultrasound echoes in response to each excitation pulse. The difference the TOF of two echoes encodes the temperature distribution in the segment bound by the echogenic features that created them; then 2. parametrizing admissible temperature distributions within each segment by requiring that unknown distribution to satisfy an appropriate heat transport or other model or by prescribing its functional form which, in turn, depends on one or more unknown parameters, which are found from ultrasonic and other available measurements.

As used herein, an echogenic feature refers to an artifact in the fiber which causes sudden change in acoustic impedance along the waveguide, particularly a fiber waveguide. The echogenic feature inherently causes a partial or complete reflection of ultrasonic pulses without separate energy input and which circumscribes the waveguide or fiber for robust signal echo. Notches which subtend only a portion of the circumference are not considered echogenic features.

The present invention uses ultrasonic transmission and reflected echoes with one or more longitudinally elongate fiber waveguides to perform non-invasive and non-destructive measurements of spatially distributed properties. Without limitation, in the waveguides are referred to herein as fiber waveguides or simply fibers.

The present invention measures the internal temperature distributions inside components, such as heterogenous fiber-reinforced materials, the example of which are carbon-carbon composites in which one or more fiber waveguides are embedded. Distribution of other, nonthermal, intensive properties which impact the velocity of ultrasonic propagation, such as density and elasticity, can also be measured utilizing the present invention. Both real-time and intermittent measurements can be obtained. The spatial distribution of properties may be characterized on a line, surface, or volume.

The calibration relationship for the waveguide material establishes the relationship between the velocity of the ultrasonic propagation, c, and the unknown property distribution under consideration. For example, to measure the temperature distribution, one of skill will establish, theoretically or empirically, the relationship between the speed of sound and the temperature: c=c(T). For calibration one of skill selects the number, lengths, and the placement of fiber waveguides within the structure. Calibration according to the present invention may advantageously be performed in the laboratory or at the point of use.

In one embodiment the invention comprises a system for measuring intensive properties in an extreme environment. The system comprises at least one transducer for sending and receiving an ultrasonic pulse and a plurality of longitudinally elongate fibers in ultrasonic communication with the transducer, each fiber of the plurality of fibers having a proximal end joined to the at least one transducer and a distal end remote therefrom and defining a respective length therebetween, the distal ends being disposable in an extreme environment, the lengths of the fibers being mutually different.

In another embodiment the invention comprises a system for measuring intensive properties in an extreme environment. The system comprises: at least one transducer for sending and receiving an ultrasonic pulse; a first plurality of longitudinally elongate fibers in ultrasonic communication with the transducer, each fiber of the plurality of fibers having a proximal end joined to the at least one transducer and a distal end remote therefrom and defining a respective length therebetween, the distal ends being disposable in an extreme environment, the lengths of the fibers being mutually different; a pulser generator in ultrasonic communication with the at least one transducer; and a display configured to show temperature indicia derived from processing waveforms received from the transducer.

In another embodiment the invention comprises a method for nondestructively monitoring the temperature of a component in a hostile environment. The method comprising the steps of: providing a monitoring system comprising at least one transducer for sending and receiving an ultrasonic pulse, a first plurality of longitudinally elongate fibers in ultrasonic communication with the transducer, each fiber of the plurality of fibers having a proximal end joined to the at least one transducer and a distal end remote therefrom and defining a respective length therebetween, the distal ends being disposable in an extreme environment, the lengths of the fibers being mutually different, a pulser generator in ultrasonic communication with the at least one transducer, and a display configured to show temperature indicia derived from processing waveforms received from the transducer; juxtaposing the distal ends of the first plurality of fibers with the component to be monitored; transmitting a baseline ultrasonic pulse from the at least one transducer to the first plurality distal ends and receiving a first plurality of baseline echoes therefrom; analyzing the first plurality of baseline echoes to determine a baseline waveform; waiting for a period of time; transmitting a first plurality of test ultrasonic pulse from the transducer to the first plurality of distal ends and receiving a first plurality of test echoes therefrom; analyzing the first plurality of test echoes to determine a test waveform; and comparing the baseline waveform and test waveform to discern a difference temperature difference therebetween.

### BRIEF DESCRIPTION OF THE DRAWINGS

All figures are to scale, except for those figures, or limited portions thereof, which are specifically designated as schematic.

FIG. 1A is a schematic perspective view of a transducer and fiber in an extreme environment.

FIG. 1B is a schematic representation of a system according to the present invention.

FIG. 2A is a profile photograph of a layered fiber waveguide made by additive manufacturing.

FIG. 2B is a profile photograph of an Inconel fiber waveguide having radial holes for echogenic features and a corresponding graphical illustration of the echogenic features throughout the length of the fiber waveguide.

FIG. 3A is a side elevational view of a layered fiber in a fragmentary vessel containing a hostile environment.

FIG. 3B is a side elevational view of a fiber in a fragmentary containment vessel and having embedded scatterers.

FIG. 3C is a side elevational view of a variable cross section fiber in a fragmentary containment vessel.

FIG. 3D is a schematic profile view of an indeterminate length wave guide having, from left to right, circumscription echogenic features including: reduced cross section, notch, square shoulder collar, round shoulder collar, scatterer shown in cross-hatch, adjacent notch and scatterer shown in cross-hatch.

FIG. 4 is a side elevational view of variable diameter fiber, a multi-material fiber and notched fiber and a corresponding graphical illustration of the echogenic features in these fibers.

FIG. 5A is a fragmentary perspective view of plural fibers with like plural schematic transducers in a block.

FIG. 5B is a schematic perspective view of four blocks having different patterns of fibers.

FIG. 6A is a profile view of a single transducer in communication with plural fibers and a corresponding graphical illustration of the echogenic differences between the lengths of the fiber waveguides.

FIG. 6B is a profile view of plural transducers in communication with plural fibers and a corresponding graphical illustration of of the delays, t_{of1 . . . 4}, between echoes reflected from distal ends of fibers F1 . . . F5 of different lengths.

FIG. 7A is a schematic fragmentary profile view of a fiber in a block having ordinary leakage of ultrasonic deformation.

FIG. 7B is a schematic fragmentary profile view of the fiber of FIG. 7A in a block having a defect and less leakage from a fiber than in FIG. 7A.

FIG. 8 is a profile view of a single transducer in communication with plural fibers and a corresponding graphical illustration of the acquired waveforms of the pulse-echo responses from the distal ends of the fibers having a unitless, time dependent vertical axis.

FIG. 9 is a map of the temperatures in Segment S₂ and Segment S₅ of FIG. 8.

FIG. 10 is a graphical representation of a fiber tested under two different conditions of the coating and showing a unitless, time dependent vertical axis for each condition.

### DETAILED DESCRIPTION OF THE INVENTION

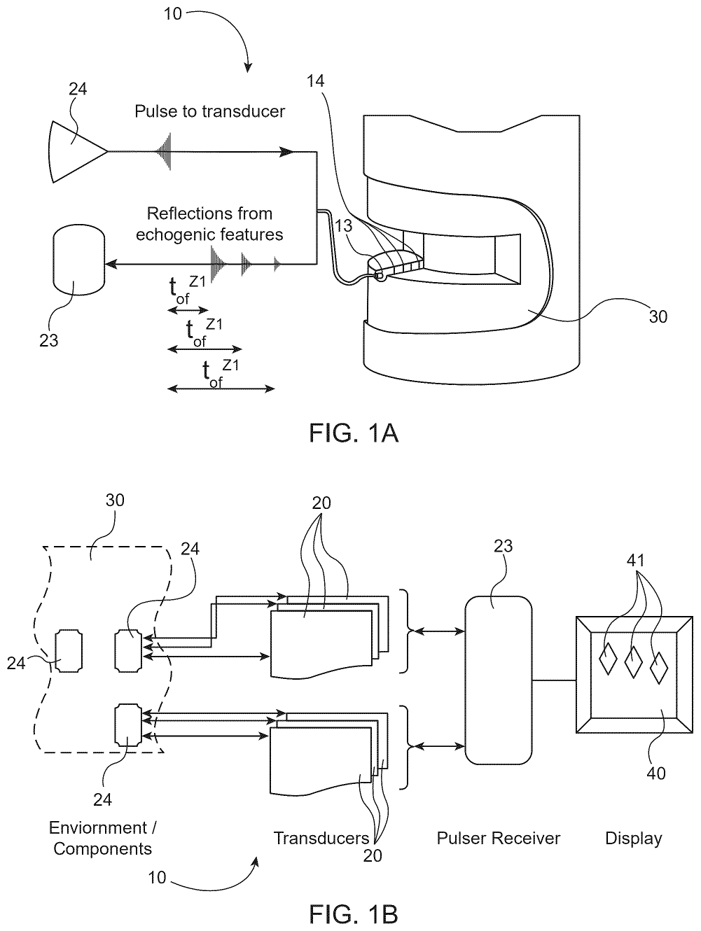

Referring to FIG. 1A, MSTD according to the present invention uses a transducer proximate the outer surface of the containment of an extreme environment. The pulser send an electrical excitation, such as a voltage pulse, a burst of voltage changes or combinations thereof, to the ultrasonic transducer. This transducer converts the electrical signal to mechanical pulses (displacements) that are transferred to the material to which the transducer is coupled. The transducer creates an ultrasonic excitation pulse, which propagates through the containment and is echogenically segmented by n−1/echogenic features located at coordinates zᵢ. In response to each probing excitation pulse, the segmentation produces a train of n echoes reflected from echogenic features and the interface with the energy conversion zone at zₙ=L, where L is the containment's thickness. The location of an echogenic feature is designated z₁, z₂, etc. S₁ is the length of a segment bound by the echogenic features. If S₁ is bounded by echogenic features at z₁ and z₂, the length S₁ is given by z₂−zᵢ. The TOF between consecutive pulses encodes the temperature specific to the segment bound by features located at zᵢ and z₍ᵢ₋₁₎ and is given by:

$${t}_{{of}_{i}} = {t}_{of}^{{z}_{i}} - {t}_{of}^{{z}_{i - 1}} = 2 {\int }_{{z}_{i - 1}}^{{z}_{i}} \frac{1}{f ( T ( z ) )} dz , \qquad ( 2 )$$

wherein the arrival times

$${t}_{of}^{{z}_{i}} and {t}_{of}^{{z}_{i - 1}}$$

of the two pulses are given by equation 2.

The present invention uses echogenically segmented fibers in ultrasonic communication with at least one transducer or plural fibers having mutually different lengths as waveguides to find unknown temperature distributions. Such fibers may be made according to Walton & Skliar, Ultrasonic Fiber Waveguides for Measuring Spatially Distributed Environmental and Material Properties, 2024 IEEE Ultrasonics, Ferroelectrics, and Frequency Control Joint Symposium (UFFC-JS), 18 Dec. 2024, ISBN 979-8-3503-7190-1, Electronic ISSN 2375-0448, DOI 10.1109/UFFC-JS60046.2024.10794113, Conference Location Taipei, Taiwan 22-26 Sep. 2024, the disclosure of which is incorporated herein by reference.

By echogencially segmented, it is meant that a feature is provided within one or more fibers to provide partial reflections of applied energy of mechanical vibrations from a transducer. The entire energy of the pulse is not reflected back towards the transducer by any one echogenic feature although the distal end of the fiber completely reflects the ultrasonic wave or remaining portion thereof. But a portion of each pulse is differentially reflected by each echogenic feature. The echogenic feature should be sized according to the desired application and property to be measured. If the echogenic feature is too small, the resulting echoes may be indistinguishable from noise or other interference. If the echogenic feature is too large, the resulting echoes may suppress reflections from more distal echogenic features.

Referring to FIG. 1B the at least one transducer is excited by a pulser receiver. A pulser receiver is an instrument which has a pulser circuit which generates electrical impulses that are applied to a transducer causing the transducer to emit an ultrasound pulse in the form of displacements within solids or pressure waves in fluids The pulser section generates short, large amplitude electric pulses of controlled energy, which are converted into short ultrasonic pulses when applied to an ultrasonic transducer. The receiver section amplifies the waveforms received by the transducer in response to mechanical displacements at its interface with a waveguide or a solid structure or a pressure wave when the transducer surface is in a fluid. The waveform may include one or more distinct echoes reflected by the echogenic features. The received pulses are typically in the radio frequency (RF) frequencies and are available as input for a display and/or capture for signal processing. A stepless gate may be used to in an analogue determine the portion of the time varying signal to be selected or rejected, as used for noise control. A Python script on a Linux computer may be used to control data acquisition, averaging and interpreting ultrasonic waveforms to estimate T(t, z), and archive the results. Suitable displays include laptop computers and oscilloscopes.

The rate at which the pulser generates transducer-excitation pulses is referred to as the Pulse Repetition Frequency (PRF). The pulser generates one pulse for each cycle of a trigger signal. The PRF control sets the pulser to be triggered by an external source or by the instrument's internal PRF oscillator, and sets the internal PRF oscillator frequency. A Pulser-Receiver may be controlled in known fashion by a host PC via a USB or Serial Port interface. The pulser receiver may be operated in the through mode o in the pulse-echo mode. The pulse echo mode is commonly used to implement the MSTD temperature measurement. A pulser receiver which produces a square wave, and particularly a negative square wave has been found suitable. A suitable pulser receiver (model 5077PR, Olympus-IMS, Waltham, MA) excites the transducer with negative square wave of 1 V to 100 V, causing a burst of elastic deformation to propagate through the fiber.

The same transducer may be used to in pulse echo mode to capture the response. Optionally, the response may be digitized for convenience. A high speed digitizer (PicoScope model 6407 Pico Technology, St. Neots, UK) may be operated at a 625 MHz sampling rate to discretize the wave echoes from the fiber. This response is then sent to a display. The displayed response may be used in signal processing to determine the unknown temperature distribution along a single echogenically segmented fiber or plural unsegmented fibers having mutually different lengths.

The fibers, in turn, are juxtaposed with and may be embedded in a block. The block may be portable and disposed as helpful in various positions in one or more extreme environments. The block may be periodically moved over time or between interrogations. Alternatively, the block may be fixed relative to the environment, as occurs with a boiler, pressure vessel, steam generator, doctor blade for a Yankee drum, aircraft wing, automobile engine block, die casting dies, etc.

The fiber materials may comprise carbon, metal, glass, and other materials through which elastic waves propagate without excessive attenuation. The invention uses time of flight (TOF) measurements of ultrasonic excitations along the fibers and within different segments of segmented fibers to characterize material or environmental properties and their spatial distributions. Examples of material properties and their distributions that may be quantified using the invention include temperature, elasticity, density, strength, and any other properties which effect changes in the ultrasound propagation velocity in the fibers. The measurements of spatially distributed properties are enabled by two embodiments described herein or the combination thereof. The embodiments are described herein for the exemplary, nonlimiting case of temperature measurements, although one of skill will recognize other intensive properties are feasible and included within the scope of the present invention.

Referring back to FIG. 1A, in a first embodiment a single, individual fiber may be echogenically segmented with plural echogenic features. The fiber may have any suitable number of echogenic features, particularly from 4 to 20 and preferably 5 to 10 echogenic features. The waveform in a single fiber produces single intermediate echoes and resulting multiple round-trip reflections. The differential TOF between consecutive echogenic features may be used to quantify the temperature within the segment intermediate adjacent echogenic features. Advantageously, sensing is not limited by fiber diameter.

An excitation pulse created by a transducer propagates through the segmented fiber- and encounters n echogenic features at locations zᵢ in the fiber. This excitation creates a train of (n+1) echoes arriving to the receiver at t_{of}^{z}^{ᵢ}. Unexpectedly, delay between consecutive echoes depends on the temperature distribution in the corresponding segment according to equation 2. For safety and preservation of instrumentation, the transducer may be placed outside the extreme environment without compromising the measurement.

The echogenic features may be equally spaced, spaced in monotonically increasing longitudinal positions as the distal end is approached or irregularly spaced as helpful to provide segments of different lengths. Advantageously, the present invention provides the flexibility to space the echogenic features at the various and predetermined points of interest in the extreme environment. Finer spacing of echogenic features improves the spatial resolution in estimating the temperature distribution. However, finely spaced echogenic features may lead to the overlap in reflected echoes and more complex response waveforms. More complex waveforms require more complex signal processing and data interpretation methods, such as full waveform inversion.

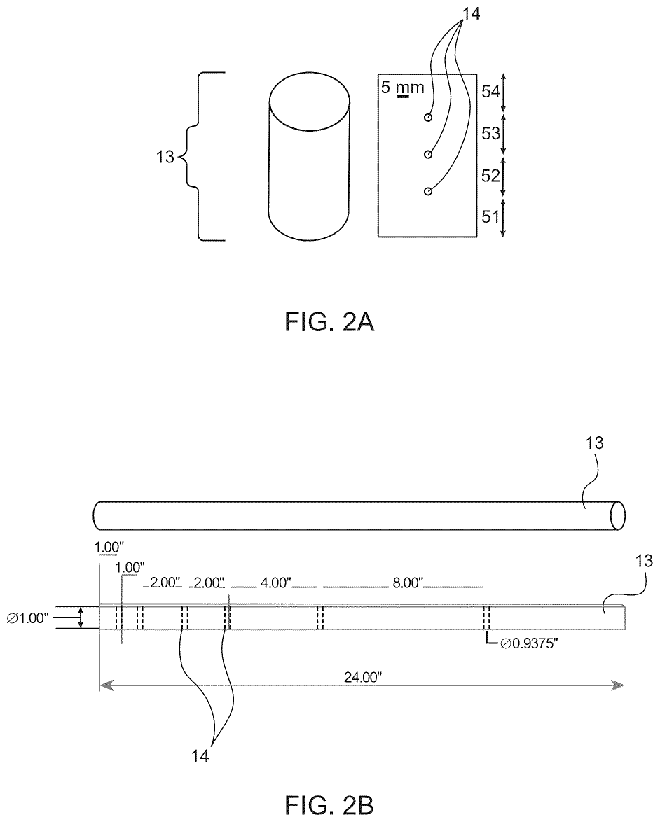

Referring to FIG. 2A and FIG. 2B, suitable fiber materials for a given application may include refractory metals, carbon, silicon carbide, and advanced ceramics. Echogenic features may be incorporated into the waveguides using any of the segmentation techniques disclosed herein. The change in the waveguide geometry is the distinct and expedient disruption the cross section which induces echogenicity.

Even with additional ultrasonic data supplied by echogenic segmentation, finding a continuous temperature distribution T(z) based on a finite, countable number of measurements was an unsolved problem in the prior art. The present invention overcomes even this problem by regularizing the temperature distribution by constraining the function form of T(z).

Referring particularly to FIG. 2B, an illustrative Inconel 625 waveguide (Special Metals Corp., New Hartford, NY) was segmented by drilling radial holes at different longitudinal locations. This Inconel 625 waveguide used to measure the temperature distribution inside a 500 MW utility boiler. It can be seen that the radial holes, and resulting echoes can be irregularly spaced in the longitudinal direction. Suitable regularization may assume a constant temperature in each segment and, therefore, the piecewise-constant distribution along the entire ultrasound propagation path. But such approximation is problematic when echogenic segmentation is coarse and thermal gradients are large. Alternatively, regularization by a piecewise-linear function according to the present invention is feasible and supersedes the piecewise-constant approximation of the prior art. The estimated temperature distribution may be fitted to satisfy a partial differential equation heat transfer model, such as given by Mason John, Kenneth Walton, Daniel Kinder, Michael A. Dayton, Mikhail Skliar, Science Direct, Ultrasonics, Ultrasonic measurement of temperature distributions in extreme environments: Electrical power plants testing in utility-scale steam generators, Volume 138, March 2024, 107205, incorporated herein by reference.

Among other factors, the design decisions will depend on the locations where one of skill wishes to measure the unknown property distribution, the spatial resolution of measurements and the type of the transducers or transducer arrays used to interrogate the fiber waveguides. For extreme environments, the orientation of the fibers must take into the consideration the stand-off location(s) where it is safe to couple the ultrasonic transducers.

Known signal processing techniques may be used to interpret the acquired waveforms in order to determine the segmental times of flight from which the segmental speed of sound is determined as needed to indicate the respective segment temperature. Algorithms may be used to measure segmental times of flight to estimate the unknown property distributions. Such algorithms may specifically utilize parameterizations or other constraints on the permissible distributions and additional measurements, both ultrasonic (e.g., provided by multiple transducers and their arrays) and not (such as thermal imaging), to aid the inversion of the measured segmental times of flight into the unknown property distributions.

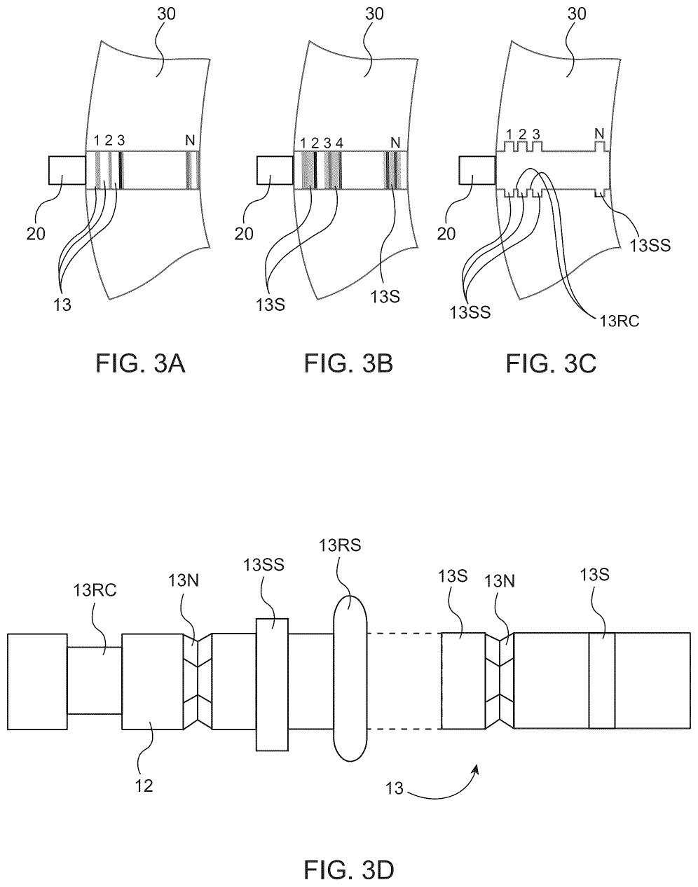

Referring to FIG. 3A, in a variant of the first embodiment, the fiber may have layered segments and particularly contiguous layered segments. Each interface between the layers produces echoes which can produce differences in ToF between layers useful to interpret temperatures at the respective interfaces between segments. The multiple echoes reflected from the interfaces in the layered segments in the fiber are aligned with the echogenic features producing the echoes acquired by a transducer in the pulse-echo mode. Layering may incorporate internal echogenic features into components and structures during additive manufacturing. For example, during fabrication, a laser beam may be rastered to melt the metal powder and form the final products layer-by-layer following the computer-aided design. The centerline-located echogenic features, seen in X-ray CT scan to segment the metal sample fabricated by the selective laser melting into four segments, have been obtained by excluding 2-mm spherical regions from the laser scan. A suitable layered fiber has been obtained by sequentially casting four layers of a Portland cement mortar mix of the same composition.

Referring to FIG. 3B, in another variant of the first embodiment, plural ultrasonic scatterers or inclusions may be dispersed along the longitudinal length of the fiber. Ultrasonic scatterers include small, localized regions where the density is different from the predominant density of the fiber material. Differences in density result in changes in acoustic impedance, which, when mismatched, create ultrasonic echoes. By longitudinally spacing the scatterers along the fiber, echoes occur at each interface and can be measured as described herein.

Referring to FIG. 3C, in another variant of the first embodiment, variations in the cross section of the fiber may be used to produce the ultrasonic echoes. For example, the fiber may have notches which reduce the cross section or collars which increase the cross section to produce the echoes. Both notches which circumscribe the fiber and collars which circumscribe the fiber are preferred over echogenic features which do not circumscribe the fiber by creating more robust echoes. More generally, features symmetric about the axis of the fiber produce more robust echoes. For example, if a notch subtends 90 degrees of the fiber, the notch may open if the fiber is bent towards the tension side or close if the fiber is bent towards the compression side, possibly distorting the intended signal in either case.

Referring to FIG. 3D, generally, an echogenic feature which circumscribes the fiber, is preferred, as a more robust echo can be obtained due to the symmetry without regard to bends and turns in the fiber from the transducer to the distal end of the fiber. This robust response may become more important as the length of the fiber increases, so that the transducer, pulser generator, display, etc. can be disposed remote from the extreme environment for safety or convenience. The fiber may have a length from the proximal end to the distal end of at least 1 cm and likely 0.01 meter to 30 meters and preferably 0.5 meters to 25 meters in order for proper and safe placement in the extreme environment. One of skill will recognize that the transducer may be directly joined to the proximal end of the fiber or may be joined by connection through a delay line therebetween.

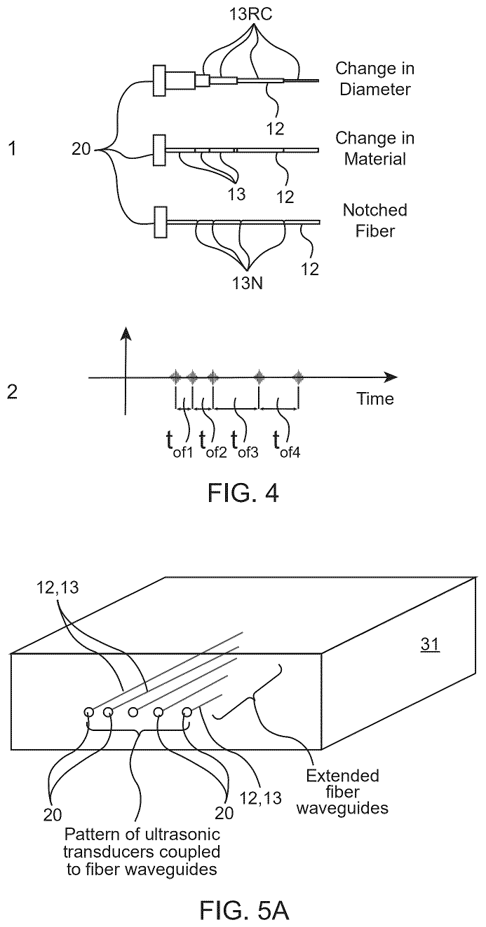

Referring to FIG. 4, variations in the fiber diameter, variations in fiber material, including scatterers, transmitters and reflectors, and variations in notched fiber cross section are shown for a single transmitter/single fiber configuration. The time axis is scaled to show the time of arrival of echoes aligned with the position of reflected echogenic features. Generally, an echogenic feature which circumscribes the fiber, such as a collar or change in diameter, is preferred, as a more robust echo can be obtained without regard to bends and turns in the fiber from the transducer to the distal end of the fiber. This circumscribing feature becomes more valuable as the inevitable curves and changes in direction along the path length occurs. And again this robust response may become more important as the length of the fiber increases, so that the transducer, pulser generator, display, etc. can be disposed remote from the extreme environment for safety.

All of these aforementioned scatterers, reflectors, inclusions, variations in cross section, variations in diameter, collars, differential materials, interfaces, etc. are generically referred to herein as echogenic features. While individual fibers having a single type of plural echogenic features are illustrated, one of skill will recognize the invention is not so limited. The echogenic features may be alike or different. Any combination of various types of echogenic features may be used in a particular fiber.

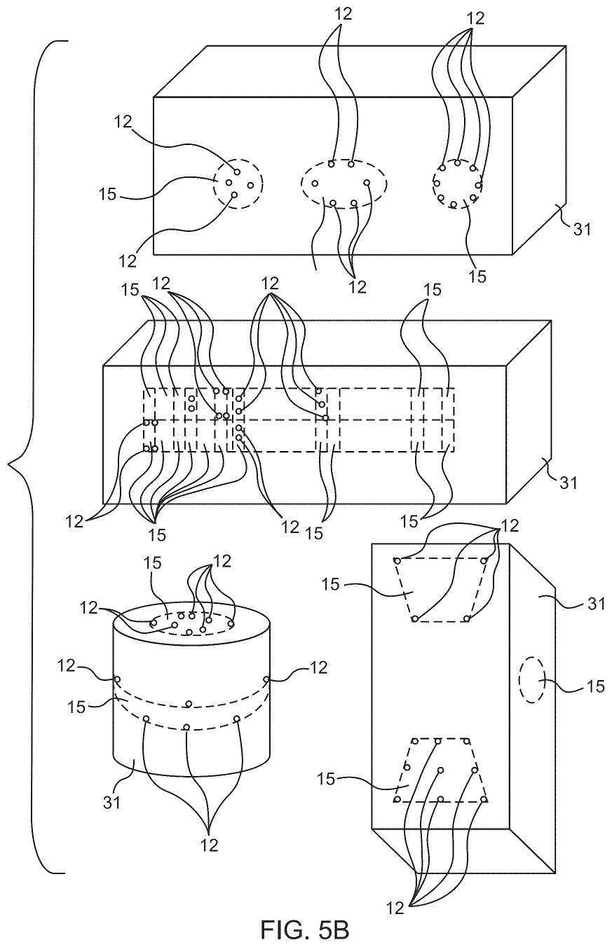

Referring to FIG. 5A, in a second embodiment, plural echogenic fibers of different lengths may be grouped together and terminate at different locations. Each fiber has a respective distal end longitudinally spaced and optionally laterally spaced from the distal ends of other fibers and particularly laterally spaced from adjacent fibers. The plural fibers are ultrasonically excited so that differences in the time of fight of ultrasonic pulses reflected in a pulse-echo mode from the distal end of fibers report on an unknown property distribution (such as temperature) in the segments defined by the differences in fiber lengths. The shortest fiber and the longest fiber may have a difference in length of 0.1 cm. to 30 cm. If the difference is too small, the differences in the property to be measured at different locations may be too small and lost in the noise. If the difference is too large, the reconstructed temperature distribution or other property of interest may be very coarse, adversely affecting accuracy or the data may even be indeterminate.

This nonlimiting example shows five parallel fibers, although one of skill will recognize any plurality of two or more fibers may be utilized. Generally, a parallel orientation of the fibers in a bundle is not essential, but may provide for convenient and optimal placement of the fibers in the extreme environment and elsewhere. Alternatively, the fibers may be braided together to conserve space and match placement in the environment. Any reasonable number of fibers having mutually different lengths may be used to create many segments, in which an unknown property of interest may be reconstructed. Each fiber is coupled to a dedicated transducer which creates an ultrasonic excitation and receives the waveform response. While this block shows five fibers colinearly disposed in a horizontal row, the invention is not so limited.

Referring to FIG. 5B, one of skill will recognize the distal ends of the fibers may be disposed in any desired pattern, depending upon the block and or environment under consideration. For example, the fibers may be disposed in patterns comprising circular patterns, rectangular patterns, elliptical patterns, grids, irregular patterns, etc. The rectangular, circular, elliptical and other polygonal patterns may comprise a single polygon or a plurality of concentric, embedded polygons, as may be used for flat surfaces, curvilinear surfaces and other solid/hollow shapes. It can be seen that a block may have fibers embedded in different faces and or different directions.

The block holding the fibers may be additively manufactured from carbon composites or other fiber-reinforced material, in which some of reinforcing fibers are used as ultrasonic waveguides to implement the invention. Other additive manufacturing methods may also be used to create thin channels for guiding ultrasonic waves. For example, the selective laser melting may be used to incorporate one or more thin internal structures guiding the elastic waves withing the structure made from dissimilar materials, or the same material with modified properties achieved by processing the channel geometry using the different energy densities of the scanning laser then the bulk material.

As additional fibers are coupled to the same transducer, the resulting waveform will gain an additional echo corresponding to the distal reflection of the added fiber. The fibers may kept out of mutual contact, despite initial findings of no detrimental impact on the waveforms. The differences in the times of flight of echoes reflected from the distal ends of fibers encode the information about the property distribution in the segment equal to the difference in the lengths of the two fibers. The time-of-flight along segments contains the necessary temperature information to reconstruct the temperature distribution in that segment and the concatenation of the segmental results gives the temperature distribution along the entire waveguide system. The temperature distribution in segment S₁ is encoded by the delay t_{of1} between echoes reflected from the distal ends of the two fibers t_{of2} encodes the temperature distribution along the segment S₂, and so on.

In this embodiment, the segmental times of flight may be simultaneously measured along multiple fibers of different lengths as the delays between echoes reflected from the distal ends of the fibers. Measurements of the segmental times of flights are localized to segments defined by the differences in lengths of the specific fibers. In a simple execution, all fibers follow similar paths from the transducer to the respective distal ends. Similarity may be achieved by braiding or bundling the fibers together.

One may also measure the temperature distribution in a volume by tomographic reconstruction from TOF measurements along multiple nonparallel fiber waveguides. When the paths traced by fiber waveguides are substantially dissimilar a hybrid approach may be used to establish the reference timing in individual fibers. The obtained characterization of the temperature distribution may be used to quantify the heat transfer and calculate heat fluxes to which fibers are exposed.

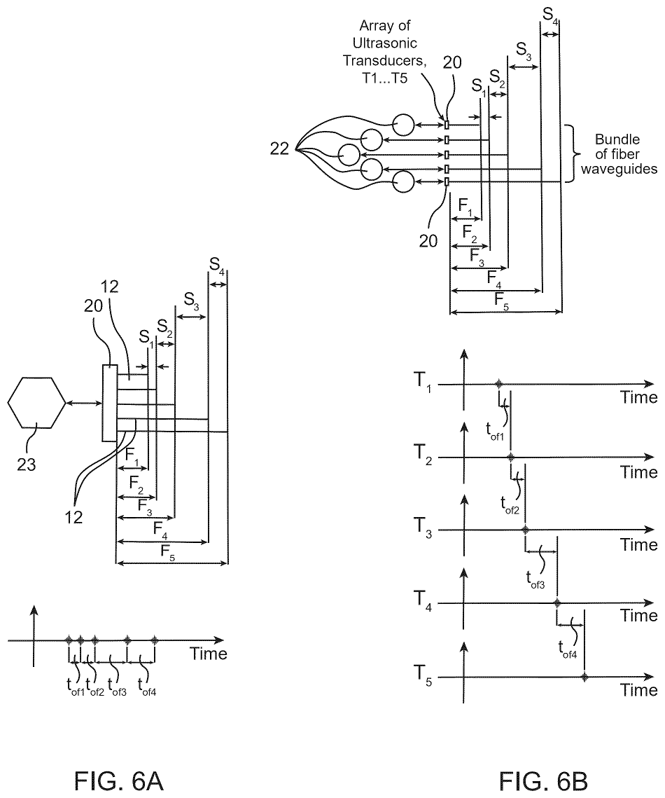

Referring to FIG. 6A, in a first variant of the second embodiment, a single common transducer may be used to create and acquire echoes in all waveguides reflected from the corresponding distal ends, as indicated by the alignment of the distal ends and respective echoes. Particularly, five fibers are shown to be coupled to a single transducer. The differences in the segmental time of flights, t_{ofi}, i=1, . . . , 4, change with the velocities of the ultrasonic propagations in segments S₁, S₂, S₃, and S₄ respectively, which, in turn, are dependent upon the intrinsic property(ies) of interest in the segments. These differences in TOF correspond to the known differences in lengths of the fibers F₁, F₂, F₃ . . . Fₛ. For example, S₁=F₂−F₁ and the changes in the ultrasonic velocity caused to changes in the temperature or other properties we wish to measure.

Referring to FIG. 6B, in a variant of the second embodiment, each fiber of the plurality of fibers is instrumented by a respective, dedicated transducer which creates an ultrasonic excitation and receives the response from a single fiber. Each transducer interrogates a single fiber. The ultrasonic waveforms acquired by the dedicated transducers T₁ . . . T₅ in communication with different fibers F₁ . . . . F₅, determine the segmental times of flight t_{of1} . . . t_{of4}, found by simultaneously analyzing waveforms acquired by each transducer, as illustrated in the lower panel. This variant has a first plurality of fibers and an identical first plurality of transducers. Again, these differences in TOF encode the property distribution in segments of length corresponding to the differences in lengths of the fibers F₁, F₂, F₃ . . . Fₛ. In another embodiment, plural transducers having plural and mutually different frequencies may be used. This arrangement provides the benefit that different frequencies may be tailored to different materials and different types of waves, such as longitudinal and shear.

The ultrasonic responses of all transducers of the plurality, are collected and provide the information on the segmental times of flight. This embodiment provides the benefit that dedicated transducers simplify the signal analysis required to determine segmental times of flight. Furthermore, MSTD may be used with many fiber waveguides driven by individual transducers without the difficulties of having ultrasonics responses from multiple fiber waveguides superimposing, overlapping, and interacting.

Exemplary implementations of plural transducers for any embodiment described and claimed herein include an array of piezoelectric micromachined ultrasonic transducers (PMUTs) and capacitive micromachined ultrasonic transducers (CMUTs). The single and array transducers may be coupled to the fibers by a direct contact (e.g., acoustic coupling of a piezoelectric transducer) or without coupling (e.g., using Electro Magnetic Acoustic Transducers, EMATs). A 5 MHz central frequency piezoelectric transducer (VIDEOSCAN® Model V609-RB, Olympus-IMS, Waltham, MA] has been found suitable for measuring temperature changes.

The guiding material may be selected to achieve a total internal reflection of the elastic waves within the guiding channel. The leakage of the ultrasound from the guide into the matrix depends on the relative acoustic impedances of the waveguide and the surrounding material, and the leakage is reduced when these values are further apart.

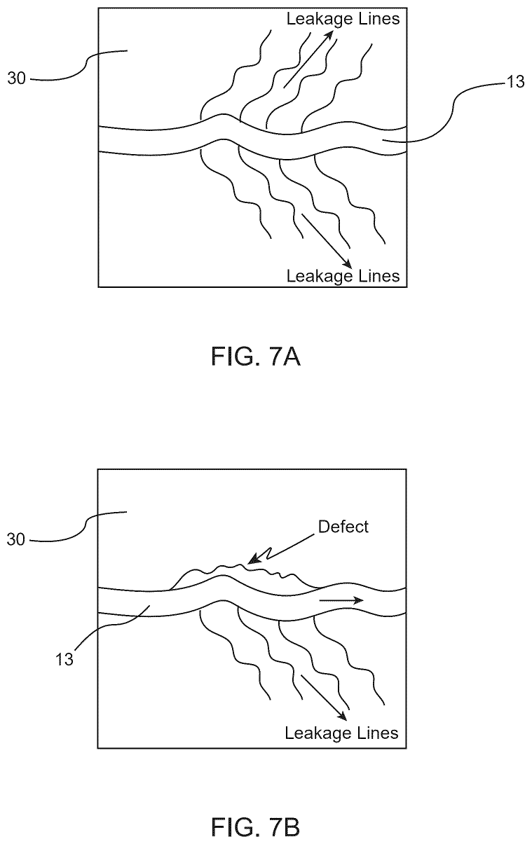

Referring to FIG. 7A, as leakage from the waveguide to environmental bulk material occurs, the leakage may be used to monitor the changes in the bulk material and the formation of defects, such as delamination between the waveguide and the matrix. Changes in the matrix properties with aging, environmental exposure, mechanical stresses, and other factors may lead to higher or lower leakage correspondingly detected by lower or high magnitude of the acquired ultrasonic echoes. Changes in echo amplitudes occur in one or a subset of embedded fibers may be used to localizes the detected changes to specific locations. This fiber has ordinary leakage of flexural wave propagation from the fiber waveguide into the surrounding matrix of the composite material.

Referring to FIG. 7B when a defect in the block occurs due to a damage, aging, or other factors, the leakage may be impacted. Particularly corresponding reduction in the leakage that leads to a higher amplitude of ultrasonic echo(es) reflected from the distal end or the waveguide, or, when present, its echogenic features. Generally, leakage does not occur through a chasm, void, crack or other defect which impairs or disrupts contact between the fibers and the block or other bulk material in which the fibers are encased. The signal may be attenuated over time. The system of the present invention can advantageously be used for nondestructive evaluation [NDE] and monitoring of aging, damage, and other factors which may adversely impact the components monitored by the fiber waveguides.

For NDE one may employ a method of nondestructively monitoring a component in a hostile environment, the method comprising the steps of: providing a monitoring system comprising a transducer for sending and receiving an ultrasonic pulse, a longitudinally elongate fiber in ultrasonic communication with the transducer and having a proximal end joined to the transducer and a distal end remote therefrom, the distal end being disposable in an extreme environment and elsewhere, the fiber being segmented by a first plurality of longitudinally spaced apart echogenic features proximate the distal end, each echogenic feature being configured to reflect a respective portion of the ultrasonic pulse back to the transducer, a pulser generator in ultrasonic communication with the transducer and a display configured to show results from processing waveforms received from the transducer; juxtaposing the distal end of the fiber and a plurality of the echogenic features juxtaposed with the component to be monitored; transmitting a baseline ultrasonic pulse from the transducer to the first plurality of echogenic features and receiving a first plurality of baseline echoes therefrom; and analyzing the first plurality of baseline echoes to determine a baseline waveform. Then one waits for a finite period of time. The period of time may be a predetermined maintenance and inspection interval or may be based on conditions and events within the environment. After waiting one continues the method by transmitting a test ultrasonic pulse from the transducer to the first plurality of echogenic features and receiving a first plurality of test echoes therefrom; analyzing the first plurality of test echoes to determine a test waveform; and comparing the baseline waveform and test waveform to discern a difference therebetween. Particularly one may look to see if attenuation occurred between the baseline echoes and test echoes. The change in attenuation above noise or the detection threshold indicates an unusual change in the component and the detection of an abnormality.

One may employ a method of nondestructively monitoring a component in a comprising using plural fibers and taking the baseline waveforms and test waveform responses to the ultrasonic excitation pulse. Such periodic excitation may be applied to periodically measure property distribution within the component and to periodically assess the change in the amplitude of the response in order to monitor the integrity (absence of damage) and subsequent changes in the material properties that impact the acoustic impedance and the leakage of elastic waves from guiding fibers into the bulk material. The distal ends of the plural fibers may be disposed in predetermined locations for measurements of the property distribution, detection of the damage and material changes, or to accomplish the combination of tasks. The fibers may be clustered together for advantageously and intensively monitoring a particular region of a component within an extreme environment. Alternatively the distal ends of the fibers may advantageously be mutually spaced apart to cover a larger region of the component under consideration. The fibers may be interrogated with constant, increasing or declining pluralities of pulses, as determined by the conditions over time.

In another embodiment one may measure the MSTD implementation of ultrasonic thermometry according to the present invention. 1. For a particular waveguide, the material is selected to withstand the harsh environment for the intended deployment period. The relationship between the speed of sound and temperature in that material is determined, for example, by preforming calibration experiments. 2. The waveguide is longitudinally segmented by spaced apart echogenic features and then juxtaposed with or embedded into the structure desired have the temperature distribution measured.

The measured segmental times of flight are used to estimate the temperature distribution along the ultrasonic propagation path. This step may use suitable parameterizations or other constraints on the permissible distributions and additional measurements, both ultrasonic (e.g., provided by multiple transducers and their arrays) and not (such as thermal imaging). A full waveform inversion technique, including machine learning implementation, may be applied to estimate the unknown temperature distribution of interest without explicitly calculating the segmental times of flight, as disclosed in M. John, K. Walton and M. Skliar, “Machine-Learning Architecture for Ultrasonic Thermometry,” 2023 IEEE International Ultrasonics Symposium (IUS), Montreal, QC, Canada, 2023, pp. 1-4, doi: 10.1109/IUS51837.2023.10307881, incorporated herein by reference.

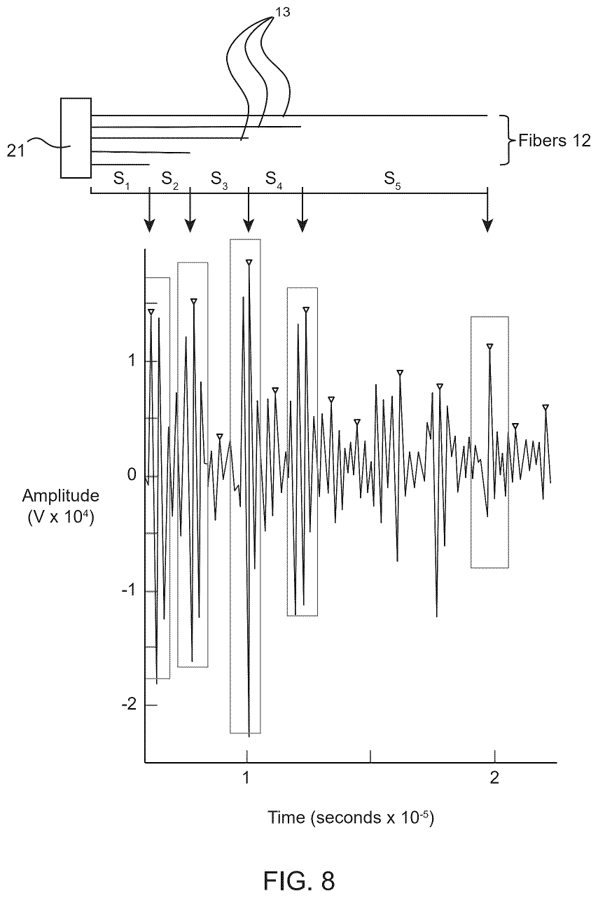

Referring to FIG. 8, the present invention has been reduced to practice with five fiber waveguides having 23.49, 35.66, 43.42, 58.16, and 99.64 mm lengths coupled and interrogated by to a single piezoelectric traducer. The fibers were SiC having a 142 um diameter. Each fiber has a carbon core ˜30 μm in diameter. The experiments were conducted with longitudinal (models V1091, 0.125″ diameter; Olympus-IMS, Waltham, MA) and shear-wave (V156, 0.25″ diameter; Olympus-IMS, Waltham, MA) transducers, both having a 5 MHz central frequency. The proximal ends of the fibers were directly coupled to the transducer face and held in place by a high viscosity SWC-2 shear wave couplant (Olympus-IMS, Waltham, MA). The room temperature velocity of the longitudinal elastic wave propagation through the fibers was measured to be 11,423 m/s, consistent with the literature. Each fiber produced a distinct echo reflecting from its distal end. The waveform was acquired for all five fibers by a longitudinal transducer operating in the pulse-echo mode. It shows the distal-end echoes aligned with the fibers' distal ends that produced and additionally identifies them with triangles. No difference in the ultrasonic response was observed when fibers were in contact with each other or separated.

The time-of-flight between echoes was measured as the temperature changed. The relationship between the time of flight of an ultrasonic pulse and the temperature was establish for individual fibers. A single fiber was placed with its proximal end coupled to the transducer on a silicone heating pad with its proximal end not in contact with the pad. A thermocouple (Type K, model KMQXL-062U-24, Omega Engineering, Norwalk, CT) was placed adjacent to the fiber's distal end. A second thermocouple was placed on the edge of the heating pad near the proximal end of the fiber. An aluminum block was placed on top of the fiber-thermocouple setup to add thermal mass, improve conductive heat transfer and reduce convective thermal losses to the environment. High thermal conductivity of the aluminum reduced temperature differences at the distal end of the fiber and the thermocouple junction in its proximity.

The graph in the lower panel of FIG. 8, shows round trip times of flight for echoes reflected from the distal ends of interrogated in a pulse-echo mode. The downward arrows indicate the echo arrival times reflected from distal ends of the respective fibers. The earliest echoes appear on the left side of the time axis, the latest echoes appear to the right side of the time axis. The segmentally different times of flight are equal to the differences in these arrival times. For example, the segmental time of flight in the S2 segment, whose length is equal to the difference in the lengths of fibers F2 and F1, is equal to the difference in the arrival times indicated by the first two downward arrows. The arrival difference between the last two echoes indicated by the two rightmost arrows is the round-trip time of flight through segment S5 equal to the difference in the lengths of fibers 5 and 4. When too many fibers are connected to the same transducer, distinct echoes may become difficult to discern, as is the case on an experimental waveform shown in the lower panel. The experimentally established relationship between the ultrasonic times of flight may and the temperature have been used to concert the measured TOFs into fiber temperatures.

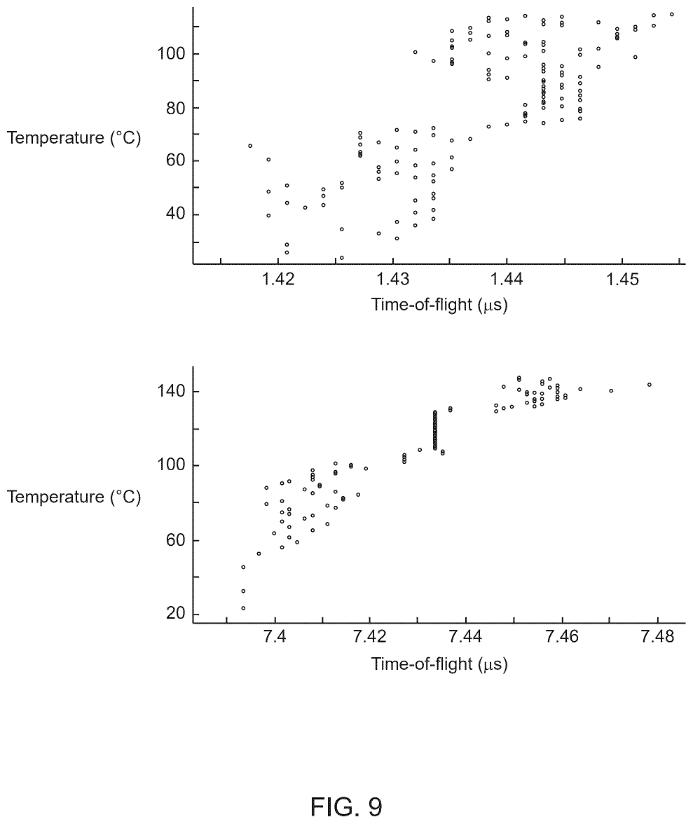

Referring to FIG. 9, for fiber S2 (top graph) and fiber S5 (bottom graph)], segmental temperature measurements in this five-fiber experiment were performed by coupling all fibers to a single V1091 transducer using the SWC-2 couplant. These fibers were spaced apart on the face of the transducer to not touch adjacent fibers. All fibers were placed on a silicone heating pad set to 200 degrees Celsius, and Type K thermocouples (model KMQXL-062U-24, DwyerOmega, Michigan City, IN) were positioned adjacent to the distal end of each fiber. The assembly of fibers and thermocouples was covered with an aluminum block. The thermocouple-recorded temperatures increased to the maximum of ˜150 degrees Celsius in a segment most removed from the edge of the heating pad. The proximal segment had the lowest temperatures. As the temperature increased in response to the setpoint change, the ultrasonic responses from the fibers were measured and used to obtain the segmental times of flight. The measured correlation between the times of flight and the temperature were used to obtain the temperatures of different segments formed by fibers of different lengths.

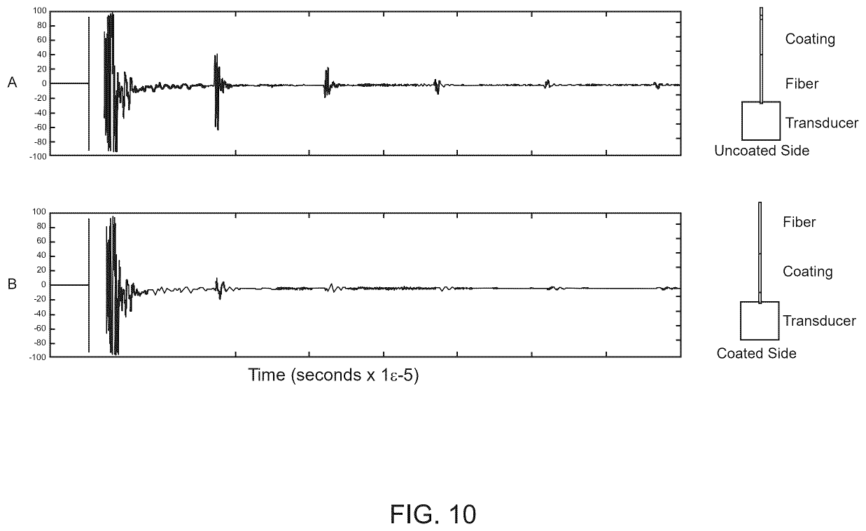

Referring to FIG. 10, the impact of the matrix properties on the leakage of elastic waves from the fiber waveguide was investigated by partially coating the fibers with Y₂Si₂O₇. The ultrasonic responses of a single 86.3-mm-long fiber partially coated with a 3.84 μm thick layer of Y₂Si₂O₇. This coating covered approximately one-third of the fiber length. Longitudinal waves were introduced into the fiber by coupling its distal end orthogonal to the face of the V1091 transducer. These experimental waveforms show multiple echoes created by the multiple reflections of the excitation pulse from the distal end of the fiber after plural round trips through the fiber.

The graph in Panel A shows the ultrasonic response of the fiber waveguide when the uncoated half the fiber was coupled to the traducer. In this case, the leakage into the coating does not occur elastic waves reaching the coated end. A stronger signal in the proximal segment of the waveguide results in a stronger distal-end reflection seen in Panel A as a higher magnitude of the echo. The graph in Panel B shows that when the orientation of the same fiber was reversed and the fiber was coupled to the traducers by the mostly coated segment first, the signal dissipated into the coating, resulting in a lower-magnitude echo reflected from the distal end. The observed sensitivity of the amplitude of ultrasonic responses to the properties and the structure of the matrix, in which the fiber waveguides are embedded and represented by partially coated fibers, illustrates the applicability of the invention to the monitoring of changes in composite structures due to damage, age, etc.

This aspect of the invention uses the strength of ultrasound signals propagating through a fiber waveguide to detect changes in the material interfacing the fiber. Examples include the coating and cladding of the fibers and the matrix of fiber-reinforced composites. When changes in the interfacing material impact its acoustic impedance, the leakage of the ultrasound energy from the fiber waveguide will change and is quantified by the changing strength of the ultrasonic response. Applications of this aspect include the characterization of fiber cladding as manufactured or after aging and degradation during service life, and the matrix in which ultrasonic fiber waveguides are embedded, such as fiber-reinforced composites.

In yet another embodiment the invention may be a combination of the two variants, utilizing a first plurality of transducers to interrogate a like first plurality of fibers that are not echogenically segmented and one or more transducers dedicated to acquiring an ultrasonic response from one or more fibers with echogenic segmentation. The second embodiment may use hybrid fibers having the echogenic features described in the first embodiment.

This invention provides the benefits of non-invasively measuring internal distributions of temperature, heat flux, density, elasticity and detect spatial anisotropy. The measurements of distributions are particularly critical for applications where property gradients must be known. For example, thermal gradients are essential in the characterization of heat transfer, thermal stresses, and heat flux measurements. By way of further example, the MSTD system of the present invention may provide measurements inside an additively manufactured mold for a composite part of an aircraft with an integrated heat exchanger to control the thermoset's curing temperature during pressure forming. In contrast, prior art techniques are generally limited to measuring inlet and outlet temperatures of cold and hot streams. By using non-invasive MSTD ultrasonic structure-integrated thermometry, it is advantageously possible to characterize temperature distribution without inserting sensors.

The present invention has demonstrated in that fibers (e.g. SiC fibers, metal fibers) may be used as ultrasonic waveguides. The present invention has also demonstrated the capability to measure the time of flight (TOF) along individual coated fibers. The present invention has also demonstrated that changes in the temperature may be characterized by measuring the TOF in the fiber waveguides. Other properties known to impact ultrasound propagation, such as material strength, elasticity, and density, may also be similarly measured. Furthermore, the present invention has also demonstrated the simultaneous interrogation of multiple fibers. When fibers of different lengths are bundled together, the fibers will provide information on the spatial distribution of temperature in various locations. This knowledge may then be used to quantify heat fluxes to which the bundle of fibers is exposed.

All values disclosed herein are not strictly limited to the exact numerical values recited. Unless otherwise specified, each such dimension is intended to mean both the recited value and a functionally equivalent range surrounding that value. For example, a dimension disclosed as “40 mm” is intended to mean “about 40 mm.” The term “or” as used herein is to be interpreted as an inclusive or meaning any one or any combination. Therefore, “A, B or C” means “any of the following: A; B; C; A and B; A and C; B and C; A, B and C.” Every document cited herein, including any cross referenced or related patent or application, is hereby incorporated herein by reference in its entirety unless expressly excluded or otherwise limited. The citation of any document or commercially available component is not an admission that such document or component is prior art with respect to any invention disclosed or claimed herein or that alone, or in any combination with any other document or component, teaches, suggests or discloses any such invention. Further, to the extent that any meaning or definition of a term in this document conflicts with any meaning or definition of the same term in a document incorporated by reference, the meaning or definition assigned to that term in this document shall govern according to Phillips v. AWH Corp., 415 F.3d 1303 (Fed. Cir. 2005). All limits shown herein as defining a range may be used with any other limit defining a range of that same parameter. That is the upper limit of one range may be used with the lower limit of another range for the same parameter, and vice versa. As used herein, when two components are joined or connected the components may be interchangeably contiguously joined together or connected with an intervening element therebetween. A component joined to the distal end of another component may be juxtaposed with or joined at the distal end thereof. While particular embodiments of the present invention have been illustrated and described, it would be obvious to those skilled in the art that various other changes and modifications can be made without departing from the spirit and scope of the invention and that various embodiments described herein may be used in any combination or combinations. It is therefore intended the appended claims cover all such changes and modifications that are within the scope of this invention.

What is claimed is:

1. A system for measuring intensive properties in an extreme environment, the system comprising:
at least one transducer for sending and receiving an ultrasonic pulse; and
a plurality of longitudinally elongate fibers in ultrasonic communication with the transducer, each fiber of the plurality of fibers having a proximal end joined to the at least one transducer and a distal end remote therefrom and defining a respective length therebetween, the distal ends being disposable in an extreme environment, the lengths of the fibers being mutually different.

2. A system according to claim 1 further comprising a pulser generator in ultrasonic communication with the at least one transducer and a display configured to show results from processing waveforms received from the transducer.

3. A system according to claim 2 wherein each fiber has a length from the proximal end to the distal end of 10 meters to 30 meters, the distal ends being disposed in an extreme environment, the proximal ends and at least one transducer being remote therefrom and not within the extreme environment.

4. A system according to claim 3 wherein the first plurality of fibers has a fiber with a shortest length and a fiber with a longest length, the difference therebetween ranging from 0.1 cm to 10 cm.

5. A system according to claim 2 wherein the transducer and pulser generator are configured to determine respective temperatures at the distal ends of the fibers.

6. A system according to claim 5 having a first plurality of fibers and an identical first plurality of transducers wherein each fiber is in ultrasonic communication with a dedicated transducer.

7. A system according to claim 5 wherein at least some of the fibers further comprise echogenic features disposed intermediate the proximal end and distal end thereof.

8. A system according to claim 7 wherein the echogenic features are juxtaposed with the distal ends of the respective ends of the fibers.

9. A system according to claim 8 wherein each fiber has a plurality of echogenic features which circumscribe the fiber.

10. A system for measuring intensive properties in an extreme environment, the system comprising:
at least one transducer for sending and receiving an ultrasonic pulse;
a first plurality of longitudinally elongate fibers in ultrasonic communication with the transducer, each fiber of the plurality of fibers having a proximal end joined to the at least one transducer and a distal end remote therefrom and defining a respective length therebetween, the distal ends being disposable in an extreme environment, the lengths of the fibers being mutually different;
a pulser generator in ultrasonic communication with the at least one transducer; and
a display configured to show temperature indicia derived from processing waveforms received from the at least one transducer.

11. A system according to claim 10 having from 5 to 10 fibers.

12. A system according to claim 11 wherein the distal ends of the fibers are disposed in a common block, the block being portable within the extreme environment.

13. A system according to claim 12 wherein the distal ends of the fibers are disposed in a colinear pattern within the block.

14. A system according to claim 12 wherein the distal ends of the fibers are disposed in a rectangular pattern within the block.

15. A system according to claim 10 wherein at least some of the fibers further comprise echogenic features circumscribing and juxtaposed with the distal ends of the fibers.

16. A system according to claim 15 having a first plurality of fibers and an identical first plurality of transducers wherein each fiber is in ultrasonic communication with a dedicated transducer.

17. A method of nondestructively monitoring the temperature of a component in a hostile environment, the method comprising the steps of:
a. providing a monitoring system comprising at least one transducer for sending and receiving an ultrasonic pulse, a first plurality of longitudinally elongate fibers in ultrasonic communication with the transducer, each fiber of the plurality of fibers having a proximal end joined to the at least one transducer and a distal end remote therefrom and defining a respective length therebetween, the distal ends being disposable in an extreme environment, the lengths of the fibers being mutually different, a pulser generator in ultrasonic communication with the at least one transducer, and a display configured to show temperature indicia derived from processing waveforms received from the transducer;
b. juxtaposing the distal ends of the first plurality of fibers with the component to be monitored;
c. transmitting a baseline ultrasonic pulse from the at least one transducer to the first plurality distal ends and receiving a first plurality of baseline echoes therefrom;
d. analyzing the first plurality of baseline echoes to determine a baseline waveform;
e. waiting for a finite period of time;
f. transmitting a first plurality of test ultrasonic pulses from the transducer to the first plurality of distal ends and receiving a first plurality of test echoes therefrom;
g. analyzing the first plurality of test echoes to determine a test waveform; and
h. comparing a baseline waveform time of flight and a test waveform time of flight to discern a difference temperature difference therebetween.

18. A method according to claim 17 further comprising repeating steps e, f, g and h at a second plurality of predetermined periods of time.

19. A method according to claim 18 further comprising the strep of disposing the distal ends of the fibers in a portable block.

20. A method according to claim 19 further comprising the step of moving the portable block during at least some of the predetermined periods of times.
